(19) United States
(12) Patent Application Publication
(10) Pub. No.: US 2023/0271862 A1
(43) Pub. Date: Aug. 31, 2023

(54) FORMULATION FOR PURIFYING RESERVOIRS FROM CYANOBACTERIA AND GREEN ALGAE

(71) Applicant: Lysterra LLC, Moscow (RU)

(72) Inventor: Vladimir Vasil'evich Zarev, Moscow (RU)

(21) Appl. No.: 18/008,263

(22) PCT Filed: Feb. 2, 2021
(86) PCT No.: PCT/IB2021/050814

§ 371 Date: Dec. 5, 2022

(30) Foreign Application Priority Data
Jun. 5, 2020 (RU) 2020118683

(51) Int. Cl. C02F 1/72; C02F 1/50; C02F 1/24

(52) U.S. Cl. CPC C02F 1/722; C02F 1/505; C02F 1/24; C02F 2103/007

(57) ABSTRACT

The invention relates to the field of disinfection and purification of reservoirs from cyanobacteria and green algae. The formulation for purifying water from cyanobacteria and green algae comprising sodium percarbonate powder and a binding agent, i.e. hydrophobizer, according to the invention comprises, as a binding agent, a hydrophobizer melt in the form of a high-melting triglyceride fraction to provide formation therebased of a superhydrophobic coating with a contact angle of 155-165°, by way of adding the hydrophobizer melt into sodium percarbonate powder heated to a temperature of 60-70°, with the following ratio of components, wt %: sodium percarbonate: 85-97 hydrophobizer melt in the form of high-melting triglyceride fractions—the remainder, followed by uniform mixing, aging at a temperature of 65° C. for no more than 5 minutes, cooling to room temperature and grinding the resulting mixture to a dispersed state with a particle size of 50-250 microns.

The invention relates to the field of disinfection and purification of reservoirs from cyanobacteria and green algae.

Known are formulations for purifying a reservoir comprising sodium percarbonate and excipients (CN104556477 (A), cl. C02F 1/28, 2015, CN107473344 (A), cl. C02F 43/36, 2017)

Further known is a nanotechnology-based formulation for chemical purification of water (CN101555061 (A), cl. C02F 43/36, 2011), consisting of sodium percarbonate powder and ALOOH (nanosized aluminum oxide) nanopowder.

A common disadvantage of the known technical solutions are high costs and difficult process of the composition preparation, as well as insufficient efficiency of purifying large reservoirs from cyanobacteria and green algae as a result of insufficient time of staying on the water surface until the active substance is completely dissolved.

Known is a technical solution comprising embodiments of buoyant, diffusing compositions for water purification from cyanobacteria and green algae (RU Patent No. 2687929, cl. C02F 103/04, 2019), one of the embodiments is the closest in terms of technical essence to the subject one, which comprises an active substance in the form of sodium percarbonate powder, a floating agent from saturated hydrocarbons, resinous materials, wax, natural or synthetic latex, and combinations thereof, for example, in the form of sawdust or rosin, etc., a binding agent, i.e. hydrophobizer, to form the coating of the active substance and swelling agent.

The process for preparing the composition includes the following steps:
thorough mixing of all components;
thereafter, feeding the resulting mixture to a 12 mm diameter granulator press, which produces beads with a thickness of approximately 7 mm and a mass of approximately 500 mg;
thereafter, incubating the beads in the oven at 115° C. for 3 minutes, removing from the oven, cooling, and grinding.

The advantage of the known technical solution is that all embodiments of the compositions are buoyant formulations of various bleaching agents that are effective in reducing the number of cyanobacteria populations in treated water.

However, the disadvantages of the known technical solution are:— using, as an active substance, of chlorine-containing agents that exhibit toxic properties when applying large amounts thereof;
using a floating agent from saturated hydrocarbons, resinous materials, wax, natural or synthetic latex and combinations thereof, which, partially or completely, do not dissolve in water, polluting the reservoir after the active substance is no more active;
using a small amount of the active substance, which dissolves within 15 hours, as a result, water has to be treated several times, and which does not eliminate the trace toxicity properties of cyanobacteria and green algae;
complexity, which increases the cost of the formulation.

The object of the invention is to provide a formulation with an active substance content of at least 70%, which can stay on the water surface for a long time while maintaining solubility and the least toxic properties.

The technical result of the subject technical solution is to obtain a synergistic effect when purifying large reservoirs, reduce the cost and expand the range of formulations for purifying water from cyanobacteria and green algae.

The technical result is achieved in that the formulation for purifying water from cyanobacteria and green algae comprising sodium percarbonate powder and a binding agent, i.e. hydrophobizer, according to the invention comprises, as a binding agent, a hydrophobizer melt in the form of a high-melting triglyceride fraction to provide formation therebased of a superhydrophobic coating with a contact angle of 155-165°, by way of adding the hydrophobizer melt into copper sulphate powder heated to a temperature of 60-70°, with the following ratio of components, wt %:

sodium percarbonate: 85-97
hydrophobizer melt in the form of
high-melting triglyceride fractions—the remainder,
followed by uniform mixing, aging at a temperature of 65° C. for no more than 5 minutes, cooling to room temperature and grinding the resulting mixture to a dispersed state with a particle size of 50-250 microns.

The novelty of the claimed solution is that, to achieve the technical result, a hydrophobizer melt in the form of a high-melting triglyceride fraction is used to form therebased a superhydrophobic coating with a contact angle of 155-165°, by way of crystallizing the surface under certain thermal conditions and qualitative states of the components that make up the formulation.

Scientific, technical and patent literature does not provide a set of features to solve the problem that previously could not be solved by known technical solutions. The prior art provides no inventions that have features that coincide with the distinctive features of the subject formulation, which fact indicates that the composition meets the patentability criterion of “inventive step”.

The industrial applicability of what is claimed is due to the fact that the preparation of the formulation is technically feasible and it can be used for cleaning reservoirs from cyanobacteria and green algae.

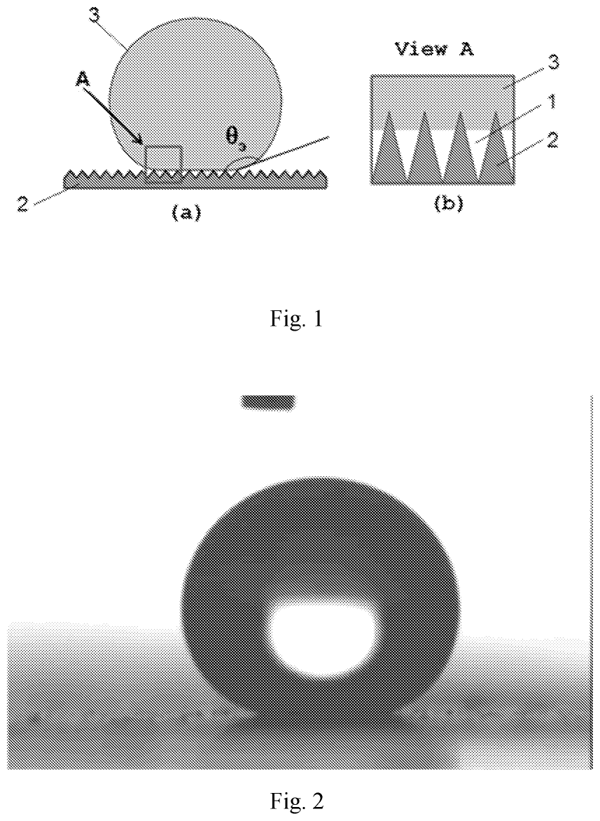

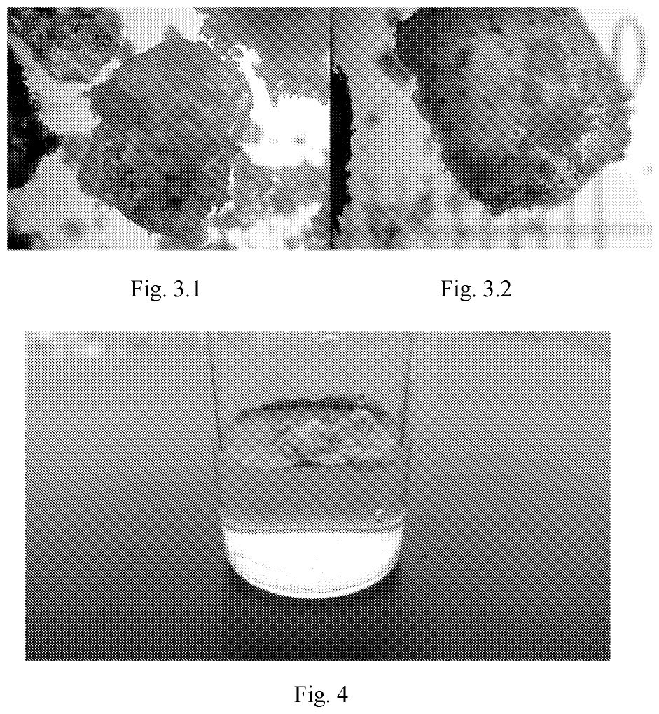

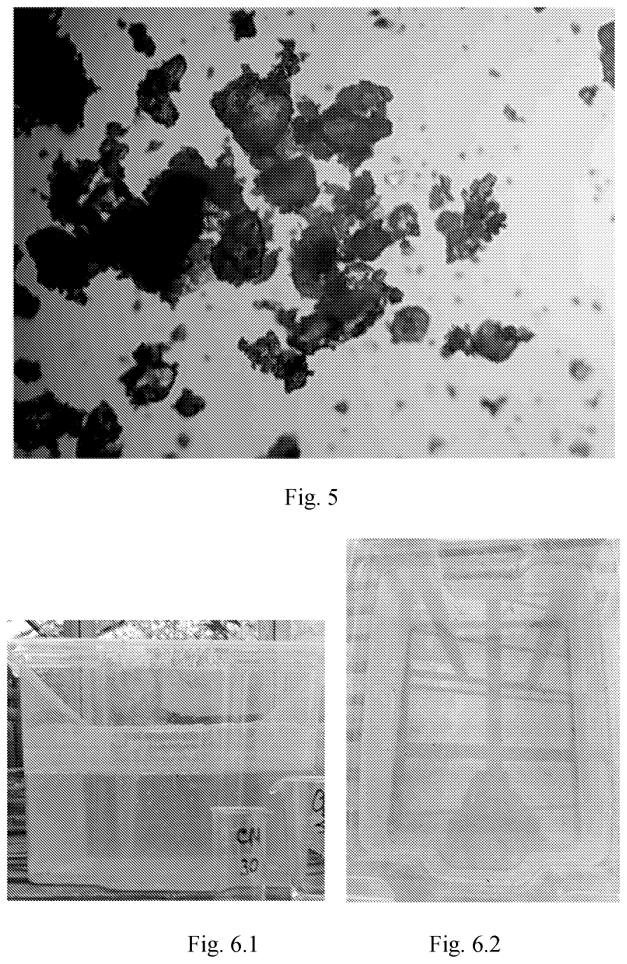

The essence of the invention is explained by drawings, where FIG. 1 (a) schematically shows the arrangement of sodium percarbonate powder treated by the hydrophobizer melt relative to fluid; (b) is a view A; FIG. 2 shows a drop of water on the surface of the sodium percarbonate powder treated by the hydrophobizer melt; FIGS. 3.1-3.2 show micrograph of particles of sodium percarbonate powder treated by the hydrophobizer melt (sample No. 4); FIG. 4 shows the testing of sample No. 4 in water; FIG. 5 shows a micrograph of crushed sample No. 4; FIGS. 6.1-6.2 show water treated by the formulation on day 12 following treatment.

The working title of the formulation for purifying reservoirs from cyanobacteria and green algae is “Vodagrad O”.

To obtain the formulation, the following components have been used:

1. As the active substance (AS): an industrial material—stabilized sodium percarbonate powder Sodium percarbonate is an inorganic compound, a crystalline solvate of sodium carbonate and hydrogen peroxide (a solvate is a compound in which solute molecules bind solvent molecules together).

Sodium percarbonate is a crystalline powdery substance with colorless crystals. It is water-soluble. It gradually decomposes with the release of oxygen and water. This process is accelerated by heating or in a humid environment when interacting with certain reagents, such as copper or iron salts.

2. A hydrophobizer melt in the form of a high-melting triglyceride fraction was used as a binding agent. The hydrophobizer melt refers to the liquid state thereof at a temperature between the critical melting point and boiling point.

The choice of a hydrophobizer for the preparation of the composition was carried out taking into account the following criteria:
the selected hydrophobizer, or more specifically a hydrophobizer-based coating must have a contact angle of not less than 90′;
the hydrophobizer must have a melting point of at least 25° C., as at such a temperature many fats (triglycerides) in the solid state exhibit a good hydrophobization;
low cost of the hydrophobizer;
the hydrophobizer must be safe.

A research showed that these requirements are met by palm oil-based emulsifiers for the food industry produced by Palsgaard® (https://vvvvw.palsgaard.ru/sustainable-emulsifiers/emulsifier-overview/)

These emulsifiers are high-melting triglyceride fractions.

The formulation for purifying reservoirs from cyanobacteria and green algae is prepared as follows.

When sodium percarbonate powder is introduced into water, it slowly or quickly, depending on the size of the particles, settles to the bottom, followed by dissolution thereof. To give the powder the ability to stay on the water surface, it is necessary to create superhydrophobic coatings characterized by contact angles of θₑ>150°. Thanks to such coatings, an air layer 1 is created between the surface of the powder 2 and the liquid 3, which fact leads to the material being pushed out to the surface of the water-air interface (FIG. 1), thanks to which fact a long remaining on the water surface is possible.

Two main conditions are to be fulfilled to create superhydrophobic coatings:

1. Create a dispersed (rough) surface structure, including the nanoscale level, by way of crystallizing the coating from the melt.

2. Hydrophobize the surface so that the value of contact angles is more than 150°.

To create a superhydrophobic coating, 85-97 g of sodium percarbonate powder was taken per 100 g of the formulation, uniformly heated to a temperature of 60-70° C., and the hydrophobizer melt (palm oil-based food emulsifier) was taken in an amount—the remainder up to 100 g and at a temperature not higher than 65° C., which corresponds to an intermediate value between the critical melting point and boiling point, and added by evenly spraying the heated powder on the surface using a spraying device, while simultaneously uniformly mixing and incubating same for no more than 5 minutes to crystallize the surface of the powder at a temperature not lower than the melting point (55° C.) of the palm oil-based food emulsifier (hydrophobizer), followed by cooling same to room temperature. The resulting mixture was then ground to a dispersed state with a particle size of 50-250 microns.

The temperature mode of heating of the copper sulphate powder (60-70° C.), hydrophobizer melt (65° C.), as well as stirring and aging for not more than 5 min at a temperature below the melting point (55° C.) of the palm oil-based food emulsifier is conditioned by the fact that such temperature combination provides a uniform crystallization of the surface of the active agent powder.

The formulation was prepared using the following equipment: a vertical mechanical agitator (https://www.ika.com/ru/Products-Lab-Eq/Overhead-Stirrers-Agitator-Blender-Lab-mixer-csp-187/), induction stove, stainless tank (10 L capacity), temperature sensor. A hammer crusher was selected to be used as a dispersing device (https://infelko.ru/drobilki/drobilki-molotkovye-molot-200-400.html). The grinding parameters (motor power: 1.5 kW, feed rate of the material for crushing: no more than 200 g/min, internal grids with a pore size of 2 mm) were selected so as to obtain, in output, a powder with a particle size ranging from 50 to 250 microns.

The formulation obtained in this manner had the superhydrophobicity effect characterized by the value of the water contact angle of 155-165° as determined by a drop sliding over the resulting coating (FIG. 2). If water drops roll on the surface of the sodium percarbonate powder coating and do not absorb therein, the coating formation process is considered uniform.

To determine the optimal quantity of components to be included in the formulation, 5 samples were created with different contents of the active substance (sodium percarbonate) and hydrophobizer melt, and experiments were conducted to determine the water contact angle of the superhydrophobic coating and the time of formulation dissolution by way of testing which was carried out by simply introducing the formulation into water.

The results are shown in Table 1.

TABLE 1
Results of experiments to determine the water contact angle of
the superhydrophobic coating and formulation dissolution time

| | Components | | Contact | |
|---|---|---|---|---|
| Sample | Sodium | Hydrophobizer | angle, | Dissolution |
| No. | percarbonate, wt % | melt, wt % | θ, ° | period, days |
| 1 | 80 | Remainder | 140 | 3 |
| 2 | 85 | Remainder | 151 | 3.5 |
| 3 | 90 | Remainder | 154 | 5 |
| 4 | 97 | Remainder | 162 | 7 |
| 5 | 99 | Remainder | 175 | — |

According to the table data, the longest periods of dissolution and remaining on the surface were observed in sample No. 4, with a 97% content of sodium percarbonate and 3% content of hydrophobizer melt. Since sample No. 4 was the most effective, only this sample is shown on the graphic material. FIG. 4 shows sample No. 4 with a longer dissolution period. Furthermore, according to the experiment, the solubility in water was not very high (the sample was completely dissolved within 7 days).

Further, microphotographs of the particles of sample No. 4 were analyzed to show that a discrete coating has been formed, the thickness of which is from 100 to 200 nm (FIGS. 3.1-3.2).

After analyzing the dispersion of the initial sodium percarbonate powder and sample No. 4, it was determined that the particle size was in the range of 200 to 3000 microns. Such sizing, according to the authors, negatively affects the buoyancy of the material and solubility thereof, and therefore, sample No. 4 was crushed to a degree of dispersion in the range of 50 to 250 microns, such particle sizing was the most effective. The particle size was controlled by the Klin grindometer (http://www.defectoscop.ru/product84.html). The optical image of the crushed sample No. 4 is shown in FIG. 5.

To prove the efficiency of the subject formulation, pilot tests were conducted.

The tests were conducted at the premises of the Federal State Funded Research Institution “All-Russian Research Institute of Biological Plant Protection” (Krasnodar), by the laboratory of genetic collection of tomato.

According to the work procedure, water samples from Lake Abrau were taken with a plankton grid (cloth No. 78) during the blue-green algae (cyanobacteria and green algae) blooming of water. To collect the biomass, the upper 1-meter layer was filtered off. In two weeks, following cultivation, water containing blue-green algae was poured into 20-liter cuvettes and the formulation was added at the rate of consumption, according to Table 2 for assessing the impact of the formulation on cyanobacteria.

The experiment lasted from 4 to 8 weeks.

After applying the formulation, the algae cells formed colonies on the surface and deposited after a while. It was further noted that, when high doses were introduced, a portion of the formulation sediments, and another portion remains on the surface. The color of the algae changed from bright green to gray-brown. In 12 days, following introducing the composition at the largest quantity thereof (5.8 kg/ha), the formation of new colonies on the bottom and walls of the vessel was not observed.

TABLE 2
Doses of the formulation in model reservoirs using
the biological material from Lake Abrau.

| | Amount of composition | |
|---|---|---|
| | on reservoir surface, | Formation of new cyanobacteria |
| Variant | kg/ha | colonies, 12 days following treatment |
| 1 | 1.8 | Vessel's bottom is entirely covered |
| | | with new cyanobacteria colonies |
| 2 | 2.8 | Vessel's bottom is partially (70%) |
| | | covered with cyanobacteria colonies |
| 3 | 3.8 | Vessel's bottom is partially (50%) |
| | | covered with cyanobacteria colonies |
| 4 | 4.8 | Vessel's bottom is partially (20%) |
| | | covered with cyanobacteria colonies |
| 5 | 5.8 | Vessel's bottom is almost clean, the |
| | | formation of colonies is observed |
| | | (5%) in some places |

In 12 days, following introducing the composition at the largest quantity thereof (5.8 kg/ha), the formation of new colonies on the bottom and walls of the vessel was not observed.

To assess the toxicity of the treated water, a garden cress (Lepidium sativum L.) bioassay was employed.

The bioassay was conducted in Petri dishes in three replicates for each sample. Filter paper discs were placed on the bottom of a Petri dish. In each dish, 30 garden cress seeds were placed on the surface of the substrate. The same filter paper discs were placed on top. The filter paper in all the dishes was moistened with water from the test samples in accordance with the variants of the experiment. One of the samples with distilled water is a control which was used in a comparative analysis with the phytotest indicators of other samples in question. Germination of seeds was carried out in a thermostatic cabinet at a temperature of 20-25° C. for 7-10 days. At the end of the experiment, the phytotest parameters were measured: seedling length, average dry weight, germinability, germinative power. The results are shown in Table 3.

TABLE 3
Measured parameters of Lepidium sativum L. formed under
the influence of the samples in question from Lake Abrau.

| | Phytotest parameters (after the second introduction) | | | |
|---|---|---|---|---|
| | Seedling | Dry | Germinability | Germination |
| Experiment | length | weight | on day 5 | power |
| variant | (mm) | (mg) | (%) | (%) |
| 1 | 112 | 1.22 | 90.7 | 80.5 |
| 2 | 125 | 1.38 | 93.0 | 82.5 |
| 3 | 143 | 1.54 | 95.3 | 88.8 |
| 4 | 152 | 1.60 | 95.5 | 92.0 |
| 5 | 162 | 1.64 | 96.2 | 92.0 |
| control | 164 | 1.76 | 96.6 | 94.2 |

The conducted studies show an acute samples' toxicity remaining after cyanobacteria in variants with a minimum dose of the formulation and show a decrease in the samples' toxic properties remaining after cyanobacteria with an increase in the dose of the formulation.

To confirm the compliance of the claimed technical solution with patentability criteria, comparative analyses were conducted to determine the novelty of features relative to the prototype (Table 4) and essential features of the formulation that allow achieving the technical result (Table 5).

TABLE 4
Examination of features for novelty.

| Prototype | Subject formulation |
|---|---|
| Water disinfection agents: chlorine- | Sodium percarbonate |
| containing agents and sodium | powder |
| percarbonate powder | |
| Floating (buoyant) agent consisting of | Not present |
| saturated hydrocarbons, resinous materials, | |
| wax, sawdust, natural or synthetic latex, | |
| and combinations thereof, which are partially | |
| or completely insoluble in water. | |
| The binding agent is hydrophobizer glyceryl | Hydrophobizer melt in the |
| stearate that does not provide formation | form of a high-melting |
| there-based of a superhydrophobic coating | triglyceride fraction to |
| | ensure the formation |
| | therebased of a |
| | superhydrophobic coating |
| Swelling agent | Not present |

TABLE 5
Examination of essential features of the subject technical solution.

| Essential features of | Novel properties acquired as | |
|---|---|---|
| the subject solution | a result of using the features | Achieved positive effect |
| Hydrophobizer melt in the | Forming a dispersed (rough) | 1. Obtaining a synergistic |
| form of a high-melting | surface structure, including | effect due to a long period of |
| triglyceride fraction | the nanoscale level, by | being on the water surface |
| Adding hydrophobizer melt | crystallizing the coating | with the preservation of |
| in sodium percarbonate powder | from the melt and | solubility and the least |
| heated to a temperature of | hydrophobizing the surface | toxic properties and |
| 60-70° | so as to ensure the | contamination of a reservoir. |
| Ratio of components, wt %: | formation of a superhydrophobic | 2. Reducing costs 3. Expanding |
| sodium percarbonate: 85-97 | coating with a contact angle | the range of formulations |
| hydrophobizer melt: remainder | of 155-165°. | for water purification |

Thus, the obtained results of pilot tests (Tables 1, 2, 3), as well as the examination of features (Tables 4, 5) allow to conclude that the subject formulation showed high efficiency in purifying reservoirs from cyanobacteria and green algae.

What is claimed is:

1. A formulation for purifying water from cyanobacteria and green algae comprising sodium percarbonate powder and a binding agent, i.e. hydrophobizer, characterized in that it comprises, as a binding agent, a hydrophobizer melt in the form of a high-melting triglyceride fraction to provide formation therebased of a superhydrophobic coating with a contact angle of 155-165°, by way of adding the hydrophobizer melt into sodium percarbonate powder heated to a temperature of 60-70°, with the following ratio of components, wt %:
sodium percarbonate: 85-97
hydrophobizer melt in the form of high-melting triglyceride fractions—the remainder, followed by uniform mixing, aging at a temperature of 65° C. for no more than 5 minutes, cooling to room temperature and grinding the resulting mixture to a dispersed state with a particle size of 50-250 microns.
